(19) United States
(12) Patent Application Publication
(10) Pub. No.: US 2022/0166007 A1
(43) Pub. Date: May 26, 2022

(54) NON-AQUEOUS ELECTROLYTE SECONDARY BATTERY

(71) Applicant: Panasonic Intellectual Property Management Co., Ltd., Osaka-shi, Osaka (JP)

(72) Inventors: Takashi Ko, Osaka (JP); Shinya Suzuki, Hyogo (JP); Fumiharu Niina, Hyogo (JP); Sho Tsuruta, Osaka (JP); Katsunori Yanagida, Hyogo (JP)

(73) Assignee: Panasonic Intellectual Property Management Co., Ltd., Osaka-shi, Osaka (JP)

(21) Appl. No.: 17/442,219

(22) PCT Filed: Jan. 27, 2020
(86) PCT No.: PCT/JP2020/002828

§ 371 Date: Sep. 23, 2021

(30) Foreign Application Priority Data
Mar. 29, 2019 (JP) 2019-065490

(51) Int. Cl. H01M 4/36; H01M 10/0525; H01M 4/525; H01M 4/505; H01M 4/58

(52) U.S. Cl. CPC H01M 4/366; H01M 10/0525; H01M 2004/028; H01M 4/505; H01M 4/5825; H01M 4/525

(57) ABSTRACT

In a nonaqueous electrolyte secondary battery, a positive electrode contains a positive electrode active material A. The positive electrode active material A includes: a lithium transition metal composite oxide represented by a general formula of LiₐNi_{b}Co_{c}Mn_{d}AlₑM_{f}O_{g} (in the formula, M is at least one element selected from Groups IV, V, and VI, and 0.8≤a≤1.2, b≥0.82, 0<c≤0.08, 0.05≤d≤0.12, 0≤e≤0.05, 0.01≤f≤0.05, and 1≤g≤2 are satisfied) in the form of particles; a first layer composed of a lithium metal compound represented by a general formula of LiₓM_{y}O_{z} (in the formula, 1≤x≤4, 1≤y≤5, and 1≤z≤12 are satisfied) and formed on each particle surface of the lithium transition metal composite oxide; and a second layer composed of a boron compound and formed on the first layer. The first layer is formed over the entire particle surface of the lithium transition metal composite oxide without the second layer being interposed therebetween.

### TECHNICAL FIELD

The present disclosure relates to a nonaqueous electrolyte secondary battery and in more particular, relates to a nonaqueous electrolyte secondary battery containing a lithium transition metal composite oxide as a positive electrode active material.

### BACKGROUND ART

Heretofore, in order to improve battery performances, such as storage characteristics, a positive electrode active material in which on surfaces of particles of a lithium transition metal composite oxide, another compound is provided has been known. For example, PTL 1 has disclosed a positive electrode active material manufactured by firing in the state in which a compound (such as TiO₂) of a predetermined element selected from Groups IV to VI, an oxide of the above element having a melting point of 750° C. or more, is provided on surfaces of particles of a lithium transition metal composite oxide. In addition, PTL 2 has disclosed a positive electrode active material which contains 0.15 percent by weight or less of carbon ions and 0.01 to 5.0 percent by weight of borate ions and which is manufactured by firing in the state in which a boric acid compound is provided on surfaces of particles of a lithium transition metal composite oxide.

### CITATION LIST

### Patent Literature

PTL 1: Japanese Published Unexamined Patent Application No. 2004-253305
PTL 2: Japanese Published Unexamined Patent Application No. 2010-040382

### SUMMARY OF INVENTION

Incidentally, in a nonaqueous electrolyte secondary battery, an initial resistance of the battery has been required to be decreased by decreasing a charge transfer resistance in a positive electrode. In addition, when a nonaqueous electrolyte secondary battery is charged and discharged in a high temperature environment, an increase in resistance is liable to occur, and to suppress the resistance increase as described above is an important subject. An object of the present disclosure is to provide a nonaqueous electrolyte secondary battery which has a low initial resistance and which is able to suppress a resistance increase during high temperature cycles.

A nonaqueous electrolyte secondary battery according to an aspect of the present disclosure is a nonaqueous electrolyte secondary battery which comprises: an electrode body including a positive electrode, a negative electrode, and a separator; and a nonaqueous electrolyte, and the positive electrode contains at least a positive electrode active material A. The positive electrode active material A includes: a lithium transition metal composite oxide represented by a general formula of LiₐNi_{b}Co_{c}Mn_{d}AlₑM_{f}O_{g} (in the formula, M is at least one element selected from Groups IV, V, and VI, and 0.08≤a≤1.2, b≥0.82, 0<c≤0.08, 0.05≤d≤0.12, 0≤e≤0.05, 0.01≤f≤0.05, and 1≤g≤2 are satisfied) in the form of particles; a first layer composed of a lithium metal compound represented by a general formula of LiₓM_{y}O_{z} (in the formula, 1≤x≤4, 1≤y≤5, and 1≤z≤12 are satisfied) and formed on each particle surface of the lithium transition metal composite oxide; and a second layer composed of a boron compound and formed on the first layer, and the first layer is formed over the entire particle surface of the lithium transition metal composite oxide without the second layer being interposed therebetween.

According to the nonaqueous electrolyte secondary battery of the above aspect of the present disclosure, an increase in battery resistance during high temperature cycles can be suppressed.

### BRIEF DESCRIPTION OF DRAWINGS

FIG. 1 FIG. 1 is a perspective view of a nonaqueous electrolyte secondary battery according to one example of an embodiment.

FIG. 2 FIG. 2 is a perspective view of an electrode body according to one example of the embodiment.

### DESCRIPTION OF EMBODIMENTS

Heretofore, it has been known that when a lithium metal compound represented by a general formula of LiₓM_{y}O_{z} is provided on particle surfaces of a lithium transition metal composite oxide, an initial resistance of a battery can be decreased. Since the lithium metal compound functions as a lithium ion conductor, the charge transfer resistance of a positive electrode is believed to be decreased. On the other hand, when the lithium metal compound is provided on the particle surfaces of the lithium transition metal composite oxide, an increase in battery resistance during high temperature cycles cannot be suppressed, and on the contrary, the resistance may be increased in some cases.

While the initial resistance is decreased, the present inventors succeeded in suppressing the resistance increase during the high temperature cycles such that a first layer composed of a lithium metal compound is formed on each particle surface of a lithium transition metal composite oxide, and a second layer composed of a boron compound is formed to cover the first layer. Since the second layer composed of a boron compound to cover the first layer is provided, a strong coating film containing M and boron is formed on the particle surface of the positive electrode active material during the high temperature cycles, a side reaction of a nonaqueous electrolyte on a positive electrode and elution of metals in the positive electrode active material are suppressed, and the increased in battery resistance is believed to be suppressed.

Hereinafter, one example of the embodiment of a nonaqueous electrolyte secondary battery according to the present disclosure will be described in detail. In the following description, although a nonaqueous electrolyte secondary battery 10 in which a winding type electrode body 14 is received in an exterior package 11 formed from laminate sheets will be described by way of example, the exterior package is not limited thereto, and for example, an exterior package can having a cylindrical shape, a square shape, or a coin shape may also be used. In addition, the electrode body may be a laminate type electrode body in which a plurality of positive electrodes and a plurality of negative electrodes are alternately laminated with a plurality of separators interposed therebetween.

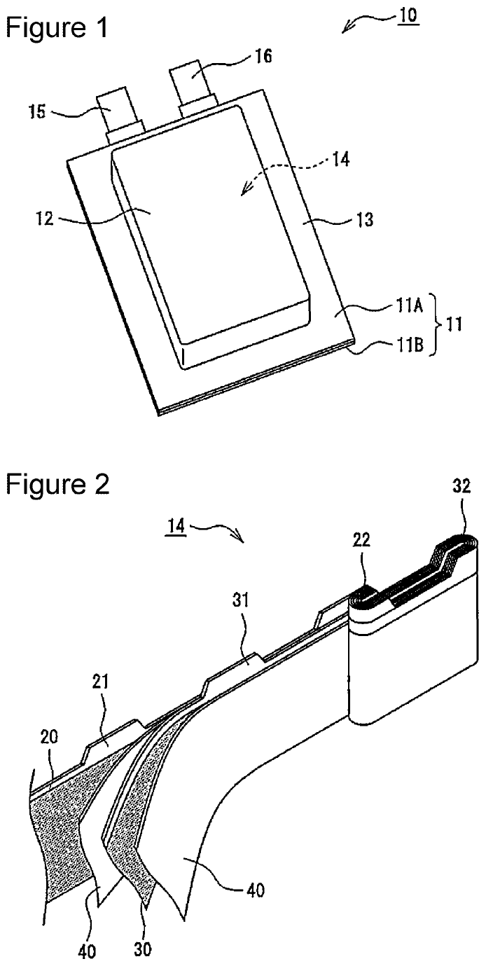

FIG. 1 is a perspective view showing an appearance of the nonaqueous electrolyte secondary battery 10 which is one example of the embodiment. As shown by way of example in FIG. 1, the nonaqueous electrolyte secondary battery 10 includes the exterior package 11 formed from 2 laminate films 11A and 11B. In addition, the nonaqueous electrolyte secondary battery 10 includes the electrode body 14 and a nonaqueous electrolyte received in the exterior package 11. The exterior package 11 has, for example, an approximately rectangular shape when viewed in plan and includes a receiving portion 12 in which the electrode body 14 and the nonaqueous electrolyte are received and a sealing portion 13 formed along a periphery of the receiving portion 12. The laminate films 11A and 11B are each formed, in general, of a resin film containing a metal layer of aluminum or the like.

The receiving portion 12 may be provided to form a recess capable of receiving the electrode body 14 in at least one of the laminate films 11A and 11B. In the example shown in FIG. 1, the recess described above is formed only in the laminate film 11A. The sealing portion 13 is formed by bonding peripheral portions of the laminate films 11A and 11B. In the example shown in FIG. 1, the sealing portion 13 is formed in a frame shape having approximately the same width so as to surround the receiving portion 12.

The nonaqueous electrolyte secondary battery 10 includes a pair of electrode leads (a positive electrode lead 15 and a negative electrode lead 16) to be connected to the electrode body 14. In the example shown in FIG. 1, the positive electrode lead 15 and the negative electrode lead 16 are extended outside of the exterior package 11 from the same end portion thereof.

The nonaqueous electrolyte contains a nonaqueous solvent and an electrolyte salt dissolved therein. As the nonaqueous solvent, for example, an ester, an ether, a nitrile, an amide, or a mixed solvent containing at least two of those mentioned above may be used. The nonaqueous solvent may include a halogen substitute in which at least one hydrogen atom of each of the solvents mentioned above is substituted by a halogen atom, such as a fluorine atom. In addition, the nonaqueous electrolyte is not limited to a liquid electrolyte and may also be a solid electrolyte using a gel polymer or the like. As the electrolyte salt, for example, a lithium salt, such as LiPF₆, may be used.

FIG. 2 is a perspective view of the electrode body 14 which is one example of the embodiment. As shown in FIG. 2 by way of example, the electrode body 14 includes a positive electrode 20, a negative electrode 30, and separators 40 and is a winding type flat-shaped electrode body in which the positive electrode 20 and the negative electrode 30 are spirally wound with the separators 40 interposed therebetween. The positive electrode 20 includes at least two positive electrode tabs 21 each having a convex shape formed of a partial electrode plate protruding in an axial direction of the electrode body 14. As is the case described above, the negative electrode 30 includes at least two negative electrode tabs 31 each protruding in the same direction as that of the positive electrode tab 21. The positive electrode tabs 21 and the negative electrode tabs 31 are formed along the longitudinal directions of the respective electrode plates at regular intervals.

The electrode body 14 is formed by overlapping and spirally winding the positive electrode 20 and the negative electrode 30 with the separators 40 interposed therebetween so that the positive electrode tabs 21 and the negative electrode tabs 31 are alternately disposed along the longitudinal directions of the respective electrode plates. In the electrode body 14, the positive electrode tabs 21 are overlapped with each other to form a positive electrode tab laminate portion 22 at one end of the electrode body 14 in the width direction, and the negative electrode tabs 31 are overlapped with each other to form a negative electrode tab laminate portion 32 at the other end of the electrode body 14 in the width direction. In addition, the positive electrode lead 15 is welded to the positive electrode tab laminate portion 22, and the negative electrode lead 16 is welded to the negative electrode tab laminate portion 32.

Hereinafter, the positive electrode 20, the negative electrode 30, and the separator 40, which form the electrode body 14, will be described, and in particular, the positive electrode 20 is described in detail.

[Positive Electrode]

The positive electrode 20 includes a positive electrode core and at least one positive electrode mixture layer provided on a surface of the positive electrode core. As the positive electrode core, for example, foil of a metal, such as aluminum, stable in a potential range of the positive electrode 20 or a film including the metal mentioned above disposed as a surface layer may be used. The positive electrode mixture layer contains a positive electrode active material, an electrically conductive material, and a binding material and is preferably provided on each of two facing surfaces of the positive electrode core except for a portion to which the positive electrode lead 15 is to be connected. The positive electrode 20 may be formed such that, for example, after a positive electrode mixture slurry containing the positive electrode active material, the electrically conductive material, the binding material, and the like is applied on the two facing surfaces of the positive electrode core, coating films thus formed are dried and compressed, so that the positive electrode mixture layers are formed on the two facing surface of the positive electrode core.

As the electrically conductive material contained in the positive electrode mixture layer, for example, a carbon material, such as a carbon black, an acetylene black, a Ketjen black, or a graphite, may be mentioned. As the binding material contained in the positive electrode mixture layer, for example, there may be mentioned a fluorine resin, such as a polytetrafluoroethylene (PTFE) or a polyvinylidene fluoride (PVdF), a polyacrylonitrile (PAN), a polyimide, an acrylic resin, or a polyolefin. At least one of those resins mentioned above may be used in combination with a cellulose derivative, such as a carboxymethyl cellulose (CMC) or its salt, or a poly(ethylene oxide) (PEO).

The positive electrode mixture layer at least contains, as the positive electrode active material, a positive electrode active material A. The positive electrode active material A includes a lithium transition metal composite oxide in the form of particles, a first layer composed of a lithium metal compound and formed on each particle surface of the lithium transition metal composite oxide, and a second layer composed of a boron compound and formed on the first layer. The positive electrode active material A is secondary particles composed of aggregated primary particles. The first layer is formed over the entire region of the particle surface of the lithium transition metal composite oxide without the second layer being interposed therebetween.

The positive electrode active material A includes, in the order from the inside of the particle, the lithium transition metal composite oxide, the first layer, and the second layer. That is, the positive electrode active material A may be regarded as core-shell particles in each of which on a surface of a core particle composed of the lithium transition metal composite oxide, a shell composed of the first layer and the second layer is formed. Since the first layer composed of the lithium metal compound is formed on the surface of the secondary particle of the lithium transition metal composite oxide, the initial resistance of the battery can be decreased, and since the second layer composed of the boron compound is formed so as to cover the first layer, the increase in battery resistance during the high temperature cycles can be suppressed.

The lithium transition metal composite oxide (hereinafter, referred to as “lithium transition metal composite oxide A” in some cases) forming the positive electrode active material A is a composite oxide represented by a general formula of LiₐNi_{b}Co_{c}Mn_{d}AlₑM_{f}O_{g} (in the formula, M is at least one element selected from Groups IV, V, and Vi, and 0.8≤a≤1.2, b≥0.82, 0<c≤0.08, 0.05≤d≤0.12, 0≤e≤0.05, 0.01≤f≤0.05, and 1≤g≤2 are satisfied). A content of Ni with respect to the total moles of the metal elements other than Li is preferably 82 to 92 percent by mole and more preferably 82 to 90 percent by mole.

In the lithium transition metal composite oxide A, a content of Co with respect to the total moles of the metal elements other than Li is preferably 3 to 8 percent by mole and more preferably 5 to 8 percent by mole. When the content of Co is more than 8 percent by mole, the resistance increase during the high temperature cycles cannot be suppressed. In addition, a content of Mn with respect to the total moles of the metal elements other than Li is preferably 6 to 10 percent by mole. When the content of Mn is less than 5 percent by mole, the resistance increase during the high temperature cycles cannot be suppressed. In addition, the lithium transition metal composite oxide A may contain at least one element other than Li, Ni, Co, Mn, and M as long as the object of the present disclosure is not deteriorated.

The first layer described above is composed of a lithium metal compound represented by a general formula Of LiₓM_{y}O_{z} (in the formula, 1≤x≤4, 1≤y≤5, and 1≤z≤12 are satisfied). The first layer may be formed so as to cover the entire surface region of the secondary particle of the lithium transition metal composite oxide A or may be dotted on the particle surface thereof.

M in the above general formula is at least one element selected from Groups IV, V, and VI and is preferably at least one selected from Ti, Nb, W, and Zr. That is, the lithium transition metal composite oxide A preferably contains at least one selected from Ti, Nb, W, and Zr. In addition, the lithium metal compound forming the first layer preferably contains at least one selected from Ti, Nb, W, and Zr. As a preferable lithium metal compound, for example, there may be mentioned Li₂TiO₃, Li₄Ti₅O₁₂, LiTiO₄, Li₂Ti₂O₅, LiTiO₂, Li₃NbO₄, LiNbO₃, Li₄Nb₂O₇, Li₈Nb₆O₁₉, Li₂ZrO₃, LiZrO₂, Li₄ZrO₄, Li₂WO₄, or Li₄WO₅.

A content of the first layer with respect to the total moles of the metal elements other than Li of the positive electrode active material A is on an M element basis in the above general formula preferably 0.001 to 1 percent by mole and more preferably 0.01 to 0.5 percent by mole. When the content of the first layer is in the range described above, the increase in battery resistance during the high temperature cycles is likely to be suppressed.

The above second layer is composed of a boron compound as described above and is formed on the first layer. The second layer preferably covers the entire region of the first layer. That is, the first layer is preferably not to be exposed to the surface of the positive electrode active material A. When the first layer is dotted on the particle surface of the lithium transition metal composite oxide A, the second layer may be partially formed directly on the particle surface of the lithium transition metal composite oxide A. The second layer may be formed so as to cover the entire region of the second particle surface of the lithium transition metal composite oxide A including the region at which the first layer is formed.

The second layer is not formed between the first layer and the secondary particle surface of the lithium transition metal composite oxide A and is only formed on the surface of the first layer facing a side opposite to the lithium transition metal composite oxide A. In addition, the lithium metal compound forming the first layer and the boron compound forming the second layer are not mixed with each other, and for example, by an XPS method, the boundary between the first layer and the second layer can be confirmed.

Although the boron compound forming the second layer is not particularly limited as long as containing B, an oxide or a lithium oxide is preferable. As one example of the boron compound, boron oxide (B₂O₃) or lithium borate (Li₂B₄O₇) may be mentioned. A content of the second layer with respect to the total moles of the metal elements other than Li of the positive electrode active material A is on a boron element basis preferably 0.1 to 1.5 percent by mole and more preferably 0.5 to 1.0 percent by mole. When the content of the second layer is in the range described above, the increase in battery resistance during the high temperature cycles is likely to be suppressed.

An average primary particle diameter of the positive electrode active material A is, for example, 100 to 1,000 nm. In addition, an average particle diameter (average secondary particle diameter) of the positive electrode active material A is, for example, 8 to 15 μm. In addition, the particle diameter of the positive electrode active material A is approximately the same as that of the lithium transition metal composite oxide A.

The average primary particle diameter of the positive electrode active material may be obtained by analysis of a SEM image of particle cross-sections observed by a scanning electron microscope (SEM). For example, after the positive electrode 20 or the positive electrode active material is buried in a resin, a cross-section thereof is formed by a cross-section polisher (CP), and this cross-section is observed by a SEM. From a SEM image, 30 primary particles are randomly selected, and grain boundaries of the primary particles are observed. In addition, after the external shapes of the primary particles are identified, the long axes (maximum diameters) of the 30 primary particles are obtained, and the average value thereof is regarded as the average primary particle diameter.

The average secondary particle diameter is also obtained from a SEM image of the cross-sections of the particles. In particular, from the above SEM image, 30 secondary particles are randomly selected, and grain boundaries of the 30 secondary particles thus selected are observed. In addition, after the external shapes of the secondary particles are identified, the long axes (maximum diameters) of the 30 secondary particles are obtained, and the average value thereof is regarded as the average secondary particle diameter.

The positive electrode active material A is manufactured, for example, by the following steps.

(1) A nickel cobalt manganese composite hydroxide is fired at 400° C. to 600° C. to form a nickel cobalt manganese composite oxide.
(2) The composite oxide described above, a lithium compound such as lithium hydroxide, and a compound containing a metal element selected from Groups IV, V, and VI are mixed together at a predetermined molar ratio and then fired in an oxygen atmosphere at 700° C. to 900° C. to form a precursor in which a lithium metal compound (first layer) represented by LiₓM_{y}O_{z} is tightly adhered to each particle surface of a lithium transition metal composite oxide.
(3) The above precursor and a boron compound are mixed together at a predetermined molar ratio and then fired in an oxygen atmosphere at 150° C. to 400° C.

The positive electrode 20 preferably contains, as the positive electrode active material, the positive electrode active material A and a positive electrode active material B. As is the positive electrode active material A, the positive electrode active material B is preferably secondary particles composed of aggregated primary particles. An average primary particle diameter of the positive electrode active material B is 0.5 μm or more and is larger than the average primary particle diameter of the positive electrode active material A. The average primary particle diameter of the positive electrode active material B is, for example, 0.5 to 4 μm. In addition, an average secondary particle diameter of the positive electrode active material B is 2 to 7 μm and is smaller than the average secondary particle diameter of the positive electrode active material A. The positive electrode active material B may be composed only of primary particles instead of the secondary particles. Since the positive electrode active material B is used in combination with the positive electrode active material A, the resistance increase during the high temperature cycles can be further suppressed.

A lithium transition metal composite oxide (hereinafter, referred to as “lithium transition metal composite oxide B” in some cases) forming the positive electrode active material B is a composite oxide represented by a general formula of LiₐNi_{b}Co_{c}Mn_{d}MₑO_{f} (in the formula, M is at least one element selected from Groups IV, V, and VI, and 0.8≤a≤1.2, b≥0.80, 0≤c≤0.15, 0≤d≤0.15, 0≤e≤0.05, and 1≤f≤2 are satisfied). The lithium transition metal composite oxide B may have a composition similar to that of the lithium transition metal composite oxide A. In addition, a content of Co in the positive electrode active material B is preferably equal to or larger than the content of Co in the positive electrode active material A.

The positive electrode active material B preferably includes a surface layer which is composed of a lithium metal compound represented by a general formula of LiₓM_{y}O_{z} (in the formula, 1≤x≤4, 1≤y≤5, and 1≤z≤12 are satisfied) and which is formed on each secondary particle surface of the lithium transition metal composite oxide B. The surface layer described above is a layer corresponding to the first laver of the positive electrode active material A and may be formed so as to cover the entire surface region of the secondary particle of the lithium transition metal composite oxide B or may be dotted on the particle surface. M in the above general formula is at least one element selected from Groups IV, V, and VI and is preferably at least one selected from Ti, Nb, W, and Zr. As a preferable lithium metal compound, for example, there may be mentioned Li₂TiO₃, Li₄Ti₅O₁₂, LiTiO₄, Li₂Ti₂O₅, LiTiO₂, Li₃NbO₄, LiNbO₃, Li₄Nb₂O₇, Li₈Nb₆O₁₉, Li₂ZrO₃, LiZrO₂, Li₄ZrO₄, Li₂WO₄, or Li₄WO₅.

A content of the surface layer in the positive electrode active material B is preferably lower than the content of the first layer in the positive electrode active material A. The content of the surface layer with respect to the total moles of the metal elements other than Li of the positive electrode active material B is on an M element basis in the above general formula preferably 0.001 to 1.0 percent by mole and more preferably 0.01 to 0.5 percent by mole. A ratio of the content of the first layer in the positive electrode active material B to the content of the first layer in the positive electrode active material A is preferably 1.1 or more.

The positive electrode active material B further preferably contains a second surface layer formed on the above surface layer. The second surface layer is a layer corresponding to the second layer of the positive electrode active material A and is composed of a boron compound. The second surface layer preferably covers the entire region of the surface layer (hereinafter, referred to as “first surface layer”) described above. When the first surface layer is dotted on the particle surface of the lithium transition metal composite oxide B, the second surface layer may be partially formed directly on the particle surface of the lithium transition metal composite oxide B.

The second surface layer is not formed between the first surface layer and the secondary particle surface of the lithium transition metal composite oxide B and is formed only on a surface of the first surface layer facing a side opposite to the lithium transition metal composite oxide A. That is, the first surface layer is formed over the entire particle surface of the lithium transition metal composite oxide B without the second surface layer being interposed therebetween.

Although the boron compound forming the second surface layer is not particularly limited as long as containing B, an oxide or a lithium oxide is preferable. As one example of the boron compound, boron oxide (B₂O₃) or lithium borate (Li₂B₄O₇) may be mentioned. A content of the second surface layer in the positive electrode active material B may be lower than the content of the second layer in the positive electrode active material A. The content of the second layer with respect to the total moles of the metal elements other than Li of the positive electrode active material B is on a boron element basis preferably 0.1 to 1.5 percent by mole and more preferably 0.5 to 1.0 percent by mole.

The positive electrode active material B is manufactured, for example, by the following steps.

(1) A nickel cobalt manganese composite hydroxide is fired at 400° C. to 600° C. to form a nickel cobalt manganese composite oxide.
(2) After the composite oxide described above, a lithium compound such as lithium hydroxide, and a compound containing a metal element selected from Groups IV, V, and VI are mixed together at a predetermined molar ratio, and an alkaline component, such as potassium hydroxide, is further added at a predetermined concentration, firing is performed in an oxygen atmosphere at 650° C. to 850° C. to form a precursor in which a lithium metal compound (first surface layer) represented by LiₓM_{y}O_{z} is tightly adhered to each particle surface of a lithium transition metal composite oxide.
(3) The above precursor and a boron compound are mixed together at a predetermined molar ratio and then fired in an oxygen atmosphere at 150° C. to 400° C.

[Negative Electrode]

The negative electrode 30 includes a negative electrode core and at least one negative electrode mixture layer provided on a surface of the negative electrode core. As the negative electrode core, for example, foil of a metal, such as copper, stable in a potential range of the negative electrode 30 or a film including the metal mentioned above disposed as a surface layer may be used. The negative electrode mixture layer contains a negative electrode active material and a binding material and is preferably provided on each of two facing surfaces of the negative electrode core except for, for example, a portion to which the negative electrode lead 16 is to be connected. The negative electrode 30 may be formed such that, for example, after a negative electrode mixture slurry containing the negative electrode active material, the binding material, and the like is applied on the two facing surfaces of the negative electrode core, coating films thus formed are dried and compressed, so that the negative electrode mixture layers are formed on the two facing surface of the negative electrode core.

In the negative electrode mixture layer, as the negative electrode active material, for example, a carbon-based active material reversibly occluding and releasing lithium ions is contained. As a preferable carbon-based active material, for example, there may be mentioned graphites including a natural graphite, such as a flaky graphite, a bulky graphite, or an earthy graphite, and an artificial graphite, such as a massive artificial graphite (MAG) or graphitized mesophase carbon microbeads (MCMB). In addition, for the negative electrode active material, a Si-based active material composed of at least one of Si and a Si-containing compound may also be used, and the carbon-based active material and the Si-based active material may be used in combination.

As the binding material contained in the negative electrode mixture layer, as is the case of the positive electrode 20, although a fluorine resin, a PAN, a polyimide, an acrylic resin, or a polyolefin resin may be used, a styrene-butadiene rubber (SBR) is preferably used. In addition, in the negative electrode mixture layer, for example, a CMC or its salt, a poly(acrylic acid) (PAA) or its salt, or a poly(vinyl alcohol) (PVA) is preferably contained. Among those mentioned above, an SBR is preferably used in combination with a CMC or its salt or a PAA or its salt.

[Separator]

As the separator 40, a porous sheet having ion permeability and insulating property is used. As a particular example of the porous sheet, for example, a fine porous thin film, a woven cloth, or a non-woven cloth may be mentioned. As a material of the separator 40, a polyolefin, such as a polyethylene or a polypropylene, or a cellulose may be preferably used. The separator 40 may have either a single layer structure or a laminate structure. On a surface of the separator, for example, a heat resistant layer may be formed.

### EXAMPLES

Hereinafter, although the present disclosure will be further described with reference to Examples, the present disclosure is not limited thereto.

### Example 1

[Synthesis of Positive Electrode Active Material A]A nickel cobalt manganese composite hydroxide obtained by co-precipitation was fired at 500° C., so that a nickel cobalt manganese composite oxide was obtained. Next, this composite oxide, lithium hydroxide, and zirconium oxide (ZrO₂) were mixed together so that a molar ratio of the total of Ni, Co, and Mn, Li, and Zr was 1:1.08:0.01. After this mixture was fired in an oxygen atmosphere at 800° C. for 20 hours, pulverization was performed, so that a positive electrode active material precursor was obtained. After this precursor and boric acid (H₃BO₃) were mixed together so that a molar ratio of the total of Ni, Co, and Mn and B was 1:0.01, this mixture was fired in an oxygen atmosphere at 300° C. for 3 hours, so that a positive electrode active material A in which the surface of the lithium metal compound (first layer) described above was covered with a boron compound (second layer) was obtained.

By an ICP method, it was confirmed that the composition of the positive electrode active material A was Li_{1.03}Ni_{0.85}Co_{0.08}Mn_{0.07}Zr_{0.01}O₂. The average primary particle diameter of the positive electrode active material A and the average particle diameter (average secondary particle diameter) thereof were 800 nm and 12.1 μm, respectively.

[Formation of Positive Electrode]

The positive electrode active material A, an acetylene black, a poly(vinylidene fluoride) (PVdF) were mixed together to have a mass ratio of 96.3:2.5:1.2, and as a dispersion medium, N-methyl-2-pyrrolidone (NMP) was used, so that a positive electrode mixture slurry was prepared. Next, after the positive electrode mixture slurry was applied on two facing surfaces of a positive electrode core composed of aluminum foil, and coating films thus formed were dried and compressed, cutting was performed to form a predetermined electrode size, so that a positive electrode in which positive electrode mixture layers were formed on the two facing surfaces of the positive electrode core was formed.

[Formation of Negative Electrode]

As a negative electrode active material, a natural graphite was used. The negative electrode active material, a sodium salt of a carboxymethyl cellulose (CMC-Na), and a styrene-butadiene rubber (SBR) were mixed together at a mass ratio of 100:1:1, and water was used as a dispersion medium, so that a negative electrode mixture slurry was prepared. Subsequently, after the negative electrode mixture slurry was applied on two facing surfaces of a negative electrode core composed of copper foil, and coating films thus formed were dried and compressed, cutting was performed to form a predetermined electrode size, so that a negative electrode in which negative electrode mixture layers were formed on the two facing surfaces of the negative electrode core was formed.

[Preparation of Nonaqueous Electrolyte Liquid]

In a mixed solvent in which ethylene carbonate (EC), ethyl methyl carbonate (EMC), and dimethyl carbonate (DMC) were mixed together at a volume ratio of 3:3:4, LiPF₆ was dissolved at a concentration of 1 mol/L. Furthermore, in this mixed solvent, vinylene carbonate (VC) was dissolved at a concentration of 2 percent by mass, so that a nonaqueous electrolyte liquid was prepared.

[Formation of Battery]

The positive electrode to which an aluminum-made positive electrode lead was fitted and the negative electrode to which a nickel-made negative electrode lead was fitted were spirally wound with polyethylene-made separators interposed therebetween and were then compressed flat, so that a winding type flat electrode body was formed. After this electrode body was received in an exterior package composed of an aluminum laminate, and the nonaqueous electrolyte liquid described above was charged therein, an opening of the exterior package was sealed, so that a nonaqueous electrolyte secondary battery having a power of 650 mAh was formed.

### Example 2

In the synthesis of the positive electrode active material A, except for that titanium oxide (TiO₂) was used instead of using ZrO₂, and the nickel cobalt manganese composite oxide, lithium hydroxide, and titanium oxide (TiO₂) were mixed together so that a molar ratio of the total of Ni, Co, and Mn, Li, and Ti was 1:1.08:0.03, a nonaqueous electrolyte secondary battery was formed in a manner similar to that of Example 1.

### Example 3

In the synthesis of the positive electrode active material A, except for that niobium oxide (Nb₂O₅) was used instead of using ZrO₂, a nonaqueous electrolyte secondary battery was formed in a manner similar to that of Example 1.

### Example 4

In the synthesis of the positive electrode active material A, except for that tungsten oxide (WO₃) was used instead of using ZrO₂, a nonaqueous electrolyte secondary battery was formed in a manner similar to that of Example 1.

### Example 5

[Synthesis of Positive Electrode Active Material B]

A nickel cobalt manganese composite hydroxide obtained by co-precipitation was fired at 500° C., so that a nickel cobalt manganese composite oxide was obtained. Subsequently, this composite oxide, lithium hydroxide, and TiO₂ were mixed together so that a molar ratio of the total of Ni, Co, and Mn, Li, and Ti was 1:1.08:0.03. Furthermore, after a potassium hydroxide solution at a concentration of 10 percent by mass was added to this mixture, and firing was performed in an oxygen atmosphere at 750° C. for 40 hours, pulverizing, washing, and drying were performed, so that a positive electrode active material B was obtained.

By an ICP method, it was confirmed that the composition of the positive electrode active material B was Li_{1.03}Ni_{0.85}Co_{0.08}Mn_{0.07}Ti_{0.03}O₂. The average primary particle diameter of the positive electrode active material B and the average secondary particle diameter thereof were 2 μm and 5 μm, respectively.

In the formation of the positive electrode, except for that as the positive electrode active material, a mixture containing the positive electrode active material A and the positive electrode active material B at a mass ratio of 7:3 was used, a nonaqueous electrolyte secondary battery was formed in a manner similar to that of Example 2.

### Example 6

In the synthesis of the positive electrode active material B, except for that the nickel cobalt manganese composite oxide, lithium hydroxide, and titanium oxide were mixed together so that a molar ratio of the total of Ni, Co, and Mn, Li, and Ti was 1:1.08:0.01, a nonaqueous electrolyte secondary battery was formed in a manner similar to that of Example 4.

### Example 7

[Synthesis of Positive Electrode Active Material B]

A nickel cobalt manganese composite hydroxide obtained by co-precipitation was fired at 500° C., so that a nickel cobalt manganese composite oxide was obtained. Subsequently, this composite oxide, lithium hydroxide, and TiO₂ were mixed together so that a molar ratio of the total of Ni, Co, and Mn, Li, and Ti was 1:1.08:0.01. Furthermore, after a potassium hydroxide solution at a concentration of 10 percent by mass was added to this mixture, and firing was performed in an oxygen atmosphere at 750° C. for 40 hours, pulverizing, washing, and drying were performed, so that a positive electrode active material precursor was obtained. After this precursor and H₃BO₃ were mixed together so that a molar ratio of the total of Ni, Co, and Mn and B was 1:0.01, this mixture was fired in an oxygen atmosphere at 300° C. for 3 hours, so that a positive electrode active material B in which the surface of the lithium metal compound (first surface layer) described above was covered with a boron compound (second surface layer) was obtained. The average primary particle diameter of the positive electrode active material B and the average secondary particle diameter thereof were 2 μm and 5 μm, respectively.

In the formation of the positive electrode, except for that a mixture in which the positive electrode active material A and the positive electrode active material B were mixed together at a mass ratio of 7:3 was used as the positive electrode active material, a nonaqueous electrolyte secondary battery was formed in a manner similar to that of Example 2.

### Comparative Example 1

In the synthesis of the positive electrode active material A, except for that TiO₂ was not mixed, H₃BO₃ was not mixed, and the firing to be performed thereafter was not performed, a nonaqueous electrolyte secondary battery was formed in a manner similar to that of Example 2. The average primary particle diameter of the positive electrode active material A and the average secondary particle diameter thereof were 740 nm and 11.1 μm, respectively.

### Comparative Example 2

In the synthesis of the positive electrode active material A, except for that TiO₂ was not mixed, a nonaqueous electrolyte secondary battery was formed in a manner similar to that of Example 2. The average primary particle diameter of the positive electrode active material A and the average secondary particle diameter thereof were 740 nm and 11.1 μm, respectively.

### Comparative Example 3

In the synthesis of the positive electrode active material A, except for that H₃BO₃ was not mixed, and the firing to be performed thereafter was not performed, a nonaqueous electrolyte secondary battery was formed in a manner similar to that of Example 2. The average primary particle diameter of the positive electrode active material A and the average secondary particle diameter thereof were 740 nm and 12.1 μm, respectively.

### Comparative Example 4

In the synthesis of the positive electrode active material A, except for that the nickel cobalt manganese composite hydroxide was synthesized so that a molar ratio of Ni, Co, and Mn was 0.82:0.12:0.06, a nonaqueous electrolyte secondary battery was formed in a manner similar to that of Example 2.

### Comparative Example 5

In the synthesis of the positive electrode active material A, except for that a lithium nickel cobalt manganese composite oxide, TiO₂, and H₃BO₃ were mixed together and then fired in an oxygen atmosphere at 300° C. for 3 hours, a nonaqueous electrolyte secondary battery was formed in a manner similar to that of Example 2. The average primary particle diameter of the positive electrode active material A and the average secondary particle diameter thereof were 700 nm and 11.8 μm, respectively.

### Comparative Example 6

In the synthesis of the positive electrode active material A, after the nickel cobalt manganese composite oxide, lithium hydroxide, and H₃BO₃ were mixed together so that a molar ratio of the total of Ni, Co, and Mn, Li, and B was 1:1.08:0.01, firing was performed in an oxygen atmosphere at 300° C. for 3 hours, so that a positive electrode active material precursor in which a boron compound was tightly adhered to a particle surface of a lithium transition metal composite oxide was obtained. After this precursor and titanium oxide were mixed together so that a molar ratio of the total of Ni, Co, and Mn and Ti was 1:0.03, firing was performed in an oxygen atmosphere at 300° C. for 3 hours, so that a positive electrode active material A was obtained. Except for that the positive electrode was formed using this positive electrode active material A, a nonaqueous electrolyte secondary battery was formed in a manner similar to that of Example 2.

### Comparative Example 7

In the synthesis of the positive electrode active material A, except for that tungsten oxide (WO₃) was used instead of using TiO₂, and the nickel cobalt manganese composite oxide, lithium hydroxide, and tungsten oxide (WO₃) were mixed together so that a molar ratio of the total of Ni, Co, and Mn, Li, and W was 1:1.08:0.01, a nonaqueous electrolyte secondary battery was formed in a manner similar to that of Comparative Example 3.

### Comparative Example 8

In the synthesis of the positive electrode active material A, except for that tungsten oxide (WO₃) was used instead of using TiO₂, a nonaqueous electrolyte secondary battery was formed in a manner similar to that of Comparative Example 4.

### Comparative Example 9

In the synthesis of the positive electrode active material A, except for that tungsten oxide (WO₃) was used instead of using TiO₂, a nonaqueous electrolyte secondary battery was formed in a manner similar to that of Comparative Example 5.

### Comparative Example 10

In the synthesis of the positive electrode active material A, except for that tungsten oxide (WO₃) was used instead of using TiO₂, a nonaqueous electrolyte secondary battery was formed in a manner similar to that of Comparative Example 6.

### Comparative Example 11

In the synthesis of the positive electrode active material A, except for that niobium oxide (Nb₂O₅) was used instead of using TiO₂, a nonaqueous electrolyte secondary battery was formed in a manner similar to that of Comparative Example 3.

### Comparative Example 12

In the synthesis of the positive electrode active material A, except for that niobium oxide (Nb₂O₅) was used instead of using TiO₂, a nonaqueous electrolyte secondary battery was formed in a manner similar to that of Comparative Example 4.

### Comparative Example 13

In the synthesis of the positive electrode active material A, except for that niobium oxide (Nb₂O₅) was used instead of using TiO₂, a nonaqueous electrolyte secondary battery was formed in a manner similar to that of Comparative Example 5.

### Comparative Example 14

In the synthesis of the positive electrode active material A, except for that niobium oxide (Nb₂O₅) was used instead of using TiO₂, a nonaqueous electrolyte secondary battery was formed in a manner similar to that of Comparative Example 6.

### Comparative Example 15

In the synthesis of the positive electrode active material A, except for that zirconium oxide (ZrO₂) was used instead of using TiO₂, a nonaqueous electrolyte secondary battery was formed in a manner similar to that of Comparative Example 3.

### Comparative Example 16

In the synthesis of the positive electrode active material A, except for that zirconium oxide (ZrO₂) was used instead of using TiO₂, a nonaqueous electrolyte secondary battery was formed in a manner similar to that of Comparative Example 4.

### Comparative Example 17

In the synthesis of the positive electrode active material A, except for that zirconium oxide (ZrO₂) was used instead of using TiO₂, a nonaqueous electrolyte secondary battery was formed in a manner similar to that of Comparative Example 5.

### Comparative Example 18

In the synthesis of the positive electrode active material A, except for that zirconium oxide (ZrO₂) was used instead of using TiO₂, a nonaqueous electrolyte secondary battery was formed in a manner similar to that of Comparative Example 6.

### Comparative Example 19

In the synthesis of the positive electrode active material A, except for that the nickel cobalt manganese composite oxide, lithium hydroxide, and titanium oxide (TiO₂) were mixed together so that a molar ratio of the total of Ni, Co, and Mn, Li, and Ti was 1:1.08:0.1, a nonaqueous electrolyte secondary battery was formed in a manner similar to that of Example 1. The positive electrode active material A was confirmed by using an XRD measurement that Li₂TiO₃ was adhered to a particle surface of the lithium transition metal composite oxide.

### Comparative Example 20

In the synthesis of the positive electrode active material A, except for that the nickel cobalt manganese composite oxide, lithium hydroxide, and niobium oxide (NbO₂) were mixed together so that a molar ratio of the total of Ni, Co, and Mn, Li, and Nb was 1:1.08:0.1, a nonaqueous electrolyte secondary battery was formed in a manner similar to that of Example 1. The positive electrode active material A was confirmed by using an XRD measurement that Li₃NiO₄ was adhered to a particle surface of the lithium transition metal composite oxide.

### Comparative Example 21

In the synthesis of the positive electrode active material A, except for that the nickel cobalt manganese composite oxide, lithium hydroxide, and zirconium oxide (ZrO₂) were mixed together so that a molar ratio of the total of Ni, Co, and Mn, Li, and Zr was 1:1.08:0.1, a nonaqueous electrolyte secondary battery was formed in a manner similar to that of Example 1. The positive electrode active material A was confirmed by using an XRD measurement that Li₂ZrO₃ was adhered to a particle surface of the lithium transition metal composite oxide.

[Evaluation of Resistance Increase Rate after High Temperature Cycle Test]

After each of the batteries of Examples and Comparative Examples was charged to a half of an initial capacity at a constant current of 0.5 It in a temperature environment at 25° C., the charge was stopped, and the battery was left for 15 minutes. Subsequently, after the battery was charged at a constant current of 0.1 It for 10 seconds, the voltage was measured at this time, and the capacity charged for 10 seconds was then discharged. This charge/discharge and the voltage measurement were repeatedly performed at a current of 0.1 to 2 It. From the relationship between the voltage and the current thus measured, the resistance was obtained and was regarded as the resistance before the cycle test.

By the cycle test performed under the following conditions, the resistance after 150 cycles was obtained by the method described above, and an increase rate of the resistance after 150 cycles to the resistance before the cycle test was calculated. The evaluation results are each shown in Table 1 as a relative value based on an increase rate of the battery of Example 1 of 100.

(Cycle Test)

After each battery was constant-current charged at a constant current of 0.5 It in a temperature environment at 60° C. until the battery voltage reached 4.2 V, a constant-voltage charge was performed at 4.2 V until the current reached 1/50 It. Subsequently, a constant-current discharge was performed at a constant current of 0.5 It until the battery voltage reached 2.5 V. This charge/discharge cycle was repeatedly performed 150 cycles.

TABLE 1

| | | | | | POSITIVE ELECTRODE | | | |
|---|---|---|---|---|---|---|---|---|
| | POSITIVE ELECTRODE ACTIVE MATERIAL A | | | | ACTIVE MATERIAL B | | | RESISTANCE |
| | | FIRST | SECOND | | YES/ | FIRST | SECOND | INCREASE |
| | Ni/Co/Mn | LAYER | LAYER | LAYER ARRANGEMENT | NO | LAYER | LAYER | RATE |
| EXAMPLE 1 | 85/8/7 | YES (M:Zr) | YES | PARTICLE/FIRST LAYER/ | NO | — | — | 100 |
| | | | | SECOND LAYER | | | | |
| EXAMPLE 2 | 85/8/7 | YES (M:Ti) | YES | PARTICLE/FIRST LAYER/ | NO | — | — | 123 |
| | | | | SECOND LAYER | | | | |
| EXAMPLE 3 | 85/8/7 | YES (M:Nb) | YES | PARTICLE/FIRST LAYER/ | NO | — | — | 149 |
| | | | | SECOND LAYER | | | | |
| EXAMPLE 4 | 85/8/7 | YES (M:W) | YES | PARTICLE/FIRST LAYER/ | NO | — | — | 140 |
| | | | | SECOND LAYER | | | | |
| EXAMPLE 5 | 85/8/7 | YES (M:Ti) | YES | PARTICLE/FIRST LAYER/ | YES | YES | NO | 90 |
| | | | | SECOND LAYER | | (A = B) | | |
| EXAMPLE 6 | 85/8/7 | YES (M:Ti) | YES | PARTICLE/FIRST LAYER/ | YES | YES | NO | 86 |
| | | | | SECOND LAYER | | (A > B) | | |
| EXAMPLE 7 | 85/8/7 | YES (M:Ti) | YES | PARTICLE/FIRST LAYER/ | YES | YES | YES | 75 |
| | | | | SECOND LAYER | | (A > B) | | |
| COMPARATIVE | 85/8/7 | NO | NO | — | NO | — | — | 302 |
| EXAMPLE 1 | | | | | | | | |
| COMPARATIVE | 85/8/7 | NO | YES | PARTICLE/SECOND LAYER | NO | — | — | 231 |
| EXAMPLE 2 | | | | | | | | |
| COMPARATIVE | 85/8/7 | YES (M:Ti) | NO | PARTICLE/FIRST LAYER | NO | — | — | 284 |
| EXAMPLE 3 | | | | | | | | |
| COMPARATIVE | 82/12/6 | YES (M:Ti) | YES | PARTICLE/FIRST LAYER/ | NO | — | — | 204 |
| EXAMPLE 4 | | | | SECOND LAYER | | | | |
| COMPARATIVE | 85/8/7 | YES (M:Ti) | YES | MIXED LAYER | NO | — | — | 185 |
| EXAMPLE 5 | | | | | | | | |
| COMPARATIVE | 85/8/7 | YES (M:Ti) | YES | PARTICLE/SECOND LAYER/ | NO | — | — | 221 |
| EXAMPLE 6 | | | | FIRST LAYER | | | | |
| COMPARATIVE | 85/8/7 | YES (M:W) | NO | PARTICLE/FIRST LAYER | NO | — | — | 290 |
| EXAMPLE 7 | | | | | | | | |
| COMPARATIVE | 82/12/6 | YES (M:W) | YES | PARTICLE/FIRST LAYER/ | NO | — | — | 241 |
| EXAMPLE 8 | | | | SECOND LAYER | | | | |
| COMPARATIVE | 85/8/7 | YES (M:W) | YES | MIXED LAYER | NO | — | — | 231 |
| EXAMPLE 9 | | | | | | | | |
| COMPARATIVE | 85/8/7 | YES (M:W) | YES | PARTICLE/SECOND LAYER/ | NO | — | — | 254 |
| EXAMPLE 10 | | | | FIRST LAYER | | | | |
| COMPARATIVE | 85/8/7 | YES (M:Nb) | NO | PARTICLE/FIRST LAYER | NO | — | — | 296 |
| EXAMPLE 11 | | | | | | | | |
| COMPARATIVE | 82/12/6 | YES (M:Nb) | YES | PARTICLE/FIRST LAYER/ | NO | — | — | 231 |
| EXAMPLE 12 | | | | SECOND LAYER | | | | |
| COMPARATIVE | 85/8/7 | YES (M:Nb) | YES | MIXED LAYER | NO | — | — | 235 |
| EXAMPLE 13 | | | | | | | | |
| COMPARATIVE | 85/8/7 | YES (M:Nb) | YES | PARTICLE/SECOND LAYER/ | NO | — | — | 240 |
| EXAMPLE 14 | | | | FIRST LAYER | | | | |
| COMPARATIVE | 85/8/7 | YES (M:Zr) | NO | PARTICLE/FIRST LAYER | NO | — | — | 278 |
| EXAMPLE 15 | | | | | | | | |
| COMPARATIVE | 82/12/6 | YES (M:Zr) | YES | PARTICLE/FIRST LAYER/ | NO | — | — | 179 |
| EXAMPLE 16 | | | | SECOND LAYER | | | | |
| COMPARATIVE | 85/8/7 | YES (M:Zr) | YES | MIXED LAYER | NO | — | — | 191 |
| EXAMPLE 17 | | | | | | | | |
| COMPARATIVE | 85/8/7 | YES (M:Zr) | YES | PARTICLE/SECOND LAYER/ | NO | — | — | 206 |
| EXAMPLE 18 | | | | FIRST LAYER | | | | |
| COMPARATIVE | 85/8/7 | YES (M:Ti) | YES | PARTICLE/FIRST LAYER/ | NO | — | — | 242 |
| EXAMPLE 19 | | | | SECOND LAYER | | | | |
| COMPARATIVE | 85/8/7 | YES (M:Nb) | YES | PARTICLE/FIRST LAYER/ | NO | — | — | 250 |
| EXAMPLE 20 | | | | SECOND LAYER | | | | |
| COMPARATIVE | 85/8/7 | YES (M:Zr) | YES | PARTICLE/FIRST LAYER/ | NO | — | — | 235 |
| EXAMPLE 21 | | | | SECOND LAYER | | | | |

As shown in Table 1, all the batteries of Examples each have a low resistance increase rate after the high temperature cycle test as compared to that of the batteries of Comparative Examples. In addition, when the positive electrode active material A and the positive electrode active material B are used together in combination (see Examples 4 to 6), the increase in the resistance can be further suppressed. On the other hand, when at least one of the first layer and the second layer is not provided on the particle surface of the lithium transition metal composite oxide (see Comparative Examples 1 to 3, 7, 11, and 15), a layer arrangement of the particle/first layer/second layer is not provided (Comparative Examples 5, 6, 9, 10, 13, 14, 17, and 18), and the lithium transition metal composite oxide has not a predetermined composition (Comparative Examples 4, 8, 12, and 16), the battery resistance was seriously increased after the high temperature cycle test.

### REFERENCE SIGNS LIST

10 nonaqueous electrolyte secondary battery
11 exterior package
12 receiving portion
13 sealing portion
14 electrode body
15 positive electrode lead
16 negative electrode lead
20 positive electrode
21 positive electrode tab
22 positive electrode tab laminate portion
30 negative electrode
31 negative electrode tab
32 negative electrode tab laminate portion
40 separator

1. A nonaqueous electrolyte secondary battery comprising: an electrode body including a positive electrode, a negative electrode, and a separator; and a nonaqueous electrolyte,
wherein the positive electrode contains at least a positive electrode active material A,
the positive electrode active material A includes:
a lithium transition metal composite oxide represented by a general formula of LiₐNi_{b}Co_{c}Mn_{d}Al_{c}M_{f}O_{g} (in the formula, M is at least one element selected from the groups IV, V, and VI, and 0.8≤a≤1.2, b≥0.82, 0<c≤0.08, 0.05≤d≤0.12, 0≤e≤0.05, 0.01≤f≤0.05, and 1≤g≤2 are satisfied) in the form of particles;
a first layer composed of a lithium metal compound represented by a general formula of LiₓM_{y}O_{z} (in the formula, 1≤x≤4, 1≤y≤5, and 1≤z≤12 are satisfied) and formed on each particle surface of the lithium transition metal composite oxide; and
a second layer composed of a boron compound and formed on the first layer, and
the first layer is formed over the entire particle surface of the lithium transition metal composite oxide without the second layer being interposed therebetween.

2. The nonaqueous electrolyte secondary battery according to claim 1,
wherein the second layer covers the entire region of the first layer.

3. The nonaqueous electrolyte secondary battery according to claim 1,
wherein M in the general formula represents at least one selected from Ti, Nb, W, and Zr.

4. The nonaqueous electrolyte secondary battery according to claim 1,
wherein the positive electrode contains the positive electrode active material A and a positive electrode active material B,
the positive electrode active materials A and B are each secondary particles composed of aggregated primary particles,
an average primary particle diameter of the positive electrode active material B is 0.5 μm or more and is larger than an average primary particle diameter of the positive electrode active material A, and
an average secondary particle diameter of the positive electrode active material B is 2 to 7 μm and is smaller than an average secondary particle diameter of the positive electrode active material A.

5. The nonaqueous electrolyte secondary battery according to claim 4,
wherein the positive electrode active material B includes a surface layer formed on a surface of each of the secondary particles,
the surface layer is composed of a lithium metal compound represented by a general formula of LiₓM_{y}O_{z} (in the formula, 1≤x≤4, 1≤y≤5, and 1≤z≤12 are satisfied), and
a content of the surface layer in the positive electrode active material B is lower than a content of the first layer in the positive electrode active material A.

6. The nonaqueous electrolyte secondary battery according to claim 5,
wherein the positive electrode active material B includes a second surface layer formed on the surface layer, and
the second surface layer is composed of a boron compound.
